(19) United States
(12) Patent Application Publication
(10) Pub. No.: US 2026/0025784 A1
(43) Pub. Date: Jan. 22, 2026

(54) INFORMATION PROCESSING METHOD AND APPARATUS, AND COMMUNICATION DEVICE AND STORAGE MEDIUM

(71) Applicant: BEIJING XIAOMI MOBILE SOFTWARE CO., LTD., Beijing (CN)

(72) Inventor: Jinhua WU, Beijing (CN)

(73) Assignee: BEIJING XIAOMI MOBILE SOFTWARE CO., LTD., Beijing (CN)

(21) Appl. No.: 18/993,214

(22) PCT Filed: Jul. 13, 2022
(86) PCT No.: PCT/CN2022/105521

§ 371 Date: Jan. 10, 2025

(51) Int. Cl. H04W 64/00

(52) U.S. Cl. CPC H04W 64/00

(57) ABSTRACT

An information processing method executed by a first device includes: sending device information of the first device to a second device, wherein the device information is used by the second device to determine that the first device has a function of positioning and/or tracking the second device.

### CROSS REFERENCE TO RELATED APPLICATION

This application is a National Stage of International Application No. PCT/CN2022/105521, filed on Jul. 13, 2022, which is incorporated by reference herein in its entireties for all purposes.

### TECHNICAL FIELD

This disclosure relates to the field of wireless communication technology but is not limited thereto, and in particular, to a method, an apparatus, a communication device and a storage medium.

### BACKGROUND

The 3GPP (3rd Generation Partnership Project) standard should support location service features in order to develop new and innovative location-based services. It should be possible to determine the current location of the terminal in a standard format (e.g., geographical coordinates) and report the same to ME (Mobile Equipment), network operators, service providers, value-added service providers and PLMN (Public Land Mobile Network) internal operators.

### SUMMARY

Embodiments of this disclosure provide an information processing method, an information processing apparatus, a communication device and a storage medium.

A first aspect of embodiments of this disclosure provides an information processing method, which is performed by a first device and includes:
sending device information of the first device to a second device, where the device information is used by the second device to determine that the first device is provided with a function of positioning and/or tracking the second device.

A second aspect of embodiments of this disclosure provides an information processing method, which is performed by a second device and includes:
receiving device information of a first device; and
determining, according to the device information, whether the first device is provided with a function of positioning and/or tracking the second device.

A third aspect of embodiments of this disclosure provides an information processing apparatus, which includes:
a sending module, configured to send device information of the apparatus to a second device, wherein the device information is used by the second device to determine that the apparatus is provided with a function of positioning and/or tracking the second device.

A fourth aspect of embodiments of this disclosure provides an information processing apparatus, which includes:
a receiving module, configured to receive device information of a first device; and
a determining module, configured to determine, according to the device information, whether the first device is provided with a function of positioning and/or tracking.

A fifth aspect of embodiments of this disclosure provides a communication device, including a processor, a transceiver, a memory, and an executable program stored in the memory and able to be executable by the processor, where the processor, upon running the executable program, is configured to implement the information processing method according to the first or second aspect described above.

A sixth aspect of embodiments of this disclosure provides a computer storage medium that stores an executable program, where the executable program is used for, upon being executed by a processor, implementing the information processing method according to the first or second aspect described above.

According to the technical solution provided by some embodiments of this disclosure, if the first device is provided with a function of positioning and/or tracking, it will send its own device information. In this way, the second device located around the first device can know that the first device provided with the function of positioning and/or tracking is present around, thereby reducing the possibility of the second device being tracked or positioned without having awareness, and improving the security of the second device's location and the user privacy.

For technical solutions provided by embodiments of this disclosure, it should be understood that the above general description and the following detailed description are only illustrative and explanatory, and do not limit the embodiments of this disclosure.

### BRIEF DESCRIPTION OF THE DRAWINGS

The accompanying drawings, which are incorporated in and constitute a part of this specification, illustrate embodiments consistent with the invention and together with the description serve to explain the principles of some embodiments of the invention.

FIG. 1 is a schematic structural diagram of a wireless communication system according to an exemplary embodiment.

FIG. 2 is a schematic flowchart of an information processing method according to an exemplary embodiment.

FIG. 3 is a schematic flowchart of an information processing method according to an exemplary embodiment.

FIG. 4 is a schematic flowchart of an information processing method according to an exemplary embodiment.

FIG. 5 is a schematic flowchart of an information processing method according to an exemplary embodiment.

FIG. 6 is a schematic flowchart of an information processing method according to an exemplary embodiment.

FIG. 7 is a schematic flowchart of an information processing method according to an exemplary embodiment.

FIG. 8 is a schematic diagram of a network architecture according to an exemplary embodiment.

FIG. 9 is a schematic diagram of a network architecture according to an exemplary embodiment.

FIG. 10 is a schematic flowchart of an information processing method according to an exemplary embodiment.

FIG. 11 is a schematic flowchart of an information processing method according to an exemplary embodiment.

FIG. 12 is a schematic flowchart of an information processing method according to an exemplary embodiment.

FIG. 13 is a schematic structural diagram of an information processing apparatus according to an exemplary embodiment.

FIG. 14 is a schematic structural diagram of an information processing apparatus according to an exemplary embodiment.

FIG. 15 is a schematic structural diagram of a UE (user equipment) according to an exemplary embodiment.

FIG. 16 is a schematic structural diagram of a communication device according to an exemplary embodiment.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with embodiments of this disclosure. Rather, they are merely examples of apparatuses and methods consistent with some aspects of embodiments of this disclosure.

The terminology used in the embodiments of this disclosure is for the purpose of describing specific embodiments only and is not intended to limit the embodiments of this disclosure. As used in the embodiments of this disclosure and the appended claims, the singular forms “a”, “an” and “the” are intended to include the plural forms as well, unless the context clearly dictates otherwise. It will also be understood that the term “and/or” as used herein refers to and includes any and all possible combinations of one or more of the associated listed items.

It should be understood that although the terms “first”, “second”, “third”, etc. may be used to describe various information in the embodiments of this disclosure, the information should not be limited to these terms. These terms are only used to distinguish information of the same type from each other. For example, without departing from the scope of the embodiments of this disclosure, the first information may also be called second information, and similarly, the second information may also be called first information. Depending on the context, the word “if” as used herein may be interpreted as “when” or “while” or “in response to determining that . . . ”

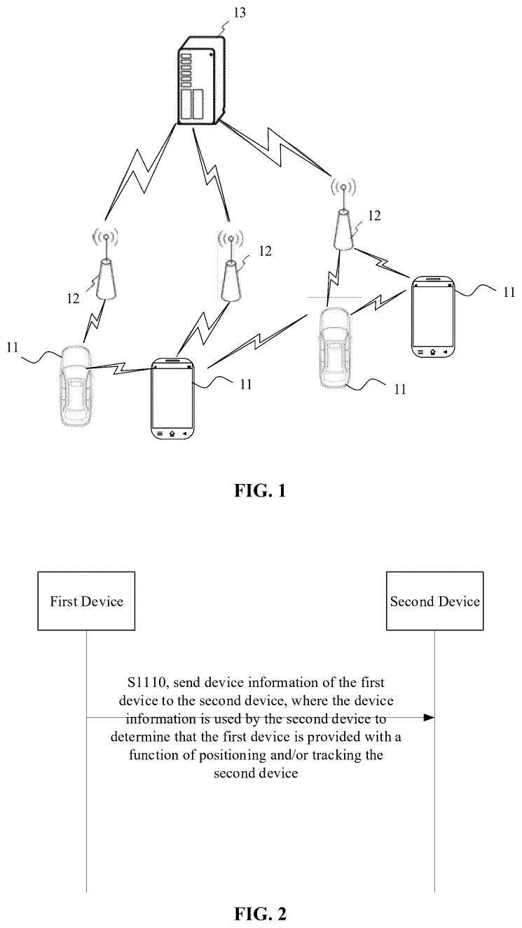

Referring to FIG. 1, which shows a schematic structural diagram of a wireless communication system according to an embodiment of this disclosure. As shown in FIG. 1, the wireless communication system is a communication system based on cellular mobile communication technology, and the wireless communication system may include: several UEs 11 and several access devices 12.

In some embodiments, UE 11 may be a device that provides voice and/or data connectivity to the user. UE 11 can communicate with one or more core networks via a radio access network (RAN), and UE 11 can be an Internet of things (IoT) UE, such as a sensor device, a mobile phone (or called “cellular” phone), and a computer with an IoT UE. For example, it may be a fixed, portable, pocket, hand-held, computer built-in, or vehicle-mounted device, such as station (STA), subscriber unit, subscriber station, mobile station, mobile, remote station, access point, remote terminal, access terminal, user terminal, user agent, user device, or UE. Alternatively, UE 11 may also be equipment of an unmanned aerial vehicle. Alternatively, UE 11 may also be a vehicle-mounted device, for example, a trip computer with a wireless communication function, or a wireless user device connected externally to the trip computer. Alternatively, UE 11 may also be a roadside device, for example, a street lamp, a signal lamp, or other roadside devices with a wireless communication function.

The access device 12 may be a network side device in the wireless communication system. In some embodiments, the wireless communication system may be the 4th generation mobile communication (4G) system, also known as the LTE (Long Term Evolution) system. Alternatively, the wireless communication system may also be the 5G system, also known as NR (new radio) system or 5G NR system. Alternatively, the wireless communication system may also be a next-generation system of the 5G system. In some embodiments, the access network in the 5G system can be called NG-RAN (New Generation-Radio Access Network). Alternatively, it may be a MTC (machine type communication) system.

In some embodiments, the access device 12 may be an eNB (evolved node-B) adopted in the 4G system. Alternatively, the access device 12 may also be a gNB adopting a centralization-distributed architecture in the 5G system. When the access device 12 adopts the centralization-distributed architecture, it generally includes a CU (central unit) and at least two DUs (distributed units). The CU is provided with a PDCP (packet data convergence protocol) layer, an RLC (radio link layer) protocol layer, a MAC (media access control) layer protocol stack; and the DU is provided with a PHY (physical) layer protocol stack. Embodiments of this disclosure do not limit the specific implementation of the access device 12.

A wireless connection may be established between the access device 12 and UE 11 through a wireless air interface. In different embodiments, the wireless air interface is a wireless air interface based on the 4G standard; alternatively, the wireless air interface is a wireless air interface based on the 5G standard, for example, a new air interface; alternatively, the wireless air interface may also be a wireless air interface based on a technical standard of a next-generation mobile communication network based on 5G.

As shown in FIG. 2, an embodiment of this disclosure provides an information processing method, which is performed by a first device. The method includes a following step(s).

In S1110, device information of the first device is sent to a second device, where the device information is used by the second device to determine that the first device has a function of positioning and/or tracking the second device.

The first device may be various devices with tracking functions. The first device includes but is not limited to IoT devices.

For example, the first device may be a device with an SL (side link) for positioning.

As another example, the first device may be a device that performs positioning through UWB (Ultra-Wide Band) technology. The first device and the second device may communicate based on SL, communicate based on WiFi direct connection, or communicate based on P2P (Point to Point).

If the first device is a legal device, for example, a device produced by a legal manufacturer, when it has a function of positioning and/or tracking, it will send its own device information and enable the second device around the first device to discover that the first device has positioning and/or tracking capabilities. The second device may be any device different from the first device.

Exemplarily, S1110 may include: in response to the first device having the function of positioning and/or tracking the second device, broadcasting the device information of the first device.

Exemplarily, S1110 may include: in response to the first device having the function of positioning and/or tracking the second device, broadcasting the device information of the first device on an SL broadcast channel; or, in response to the first device having the function of positioning and/or tracking the second device, broadcasting the device information of the first device on a WiFi broadcast channel.

For example, the device information may include at least one of the following:
device type information, indicating a type of the first device, where the first device of a specific type has the function of positioning and/or tracking the second device; some types of devices do not support the function of positioning and/or tracking, and some types of devices support the function of positioning and/or tracking;
function information, indicating that the first device has the function of positioning and/or tracking the second device.

In short, the device type information is one type of the aforementioned device information.

In this way, after the second device receives the device information, it can discover whether there is a first device with the function of positioning and/or tracking around it, thereby facilitating the second device to perform relevant operations to protect its own security and/or privacy.

In some embodiments, the device information includes:
a device identifier of the first device; and
device type information of the first device.

In some embodiments, the device type information is used by the second device to determine that the first device corresponding to the device identifier has the function of positioning and/or tracking.

In some embodiments, the device identifier of the first device may include a device number, and the device number may include a type number, which may indicate that the first device has the function of positioning and/or tracking.

In other embodiments, the device identifier of the first device can be understood as a user identifier. Exemplarily, specifically, the device identifier of the first device may include: user SUCI (Subscription Concealed Identifier), GUTI (Globally Unique Temporary UE Identity), or PET (Permanent Equipment Identifier).

The device type information may include: a type number, which may indicate that the first device has the function of positioning and/or tracking.

In some embodiments, S1110 may include:
sending an announcement message including the device information, where the announcement information includes the device information.

When the first device has the function of positioning and/or tracking the second device, the announcement message containing the device information is sent, where the announcement message includes a broadcast message.

For example, the announcement message may include a message sent on a broadcast link (or discovery link) of the SL.

As shown in FIG. 3, an embodiment of this disclosure provides an information processing method, which is performed by a first device. The method includes a following step(s)
In S1210, a request message is sent, where the request message includes the device information.

In some embodiments, the request message may include the device information that may be used to indicate the positioning and/or tracking function of the first device.

Likewise, the request message may include a message sent on the broadcast link (or discovery link) of SL. For example, the device information may include at least one of the following:
device type information, indicating that the first device has the function of positioning and/or tracking the second device;
function information, indicating that the first device has the function of positioning and/or tracking the second device.

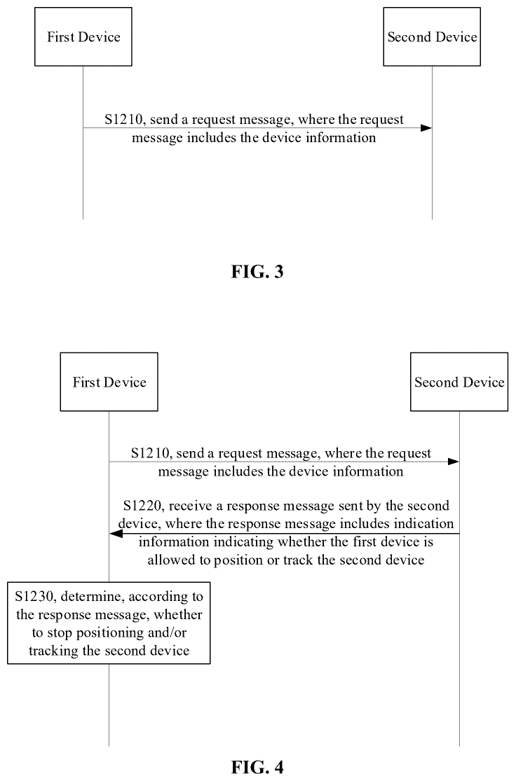

As shown in FIG. 4, an embodiment of this disclosure provides an information processing method, which is performed by a first device. The method includes a following step(s).
In S1210, a request message is sent, where the request message includes the device information.
In S1220, a response message sent by a second device is received, where the response message includes indication information indicating whether the first device is allowed to locate or track the second device.
In S1230, it is determined whether to stop positioning and/or tracking the second device according to the response message.

In some embodiments, if the second device finds that the first device is around it and does not want it to be tracked or positioned, it can indicate the first device to stop positioning itself through the response message.

Exemplarily, when the first device receives the response message containing the above indication information, it can disable its own positioning and/or tracking function, or independently stop the positioning and/or tracking process with respect to the second device that returns the indication information.

As shown in FIG. 5, an embodiment of this disclosure provides an information processing method, which is performed by a second device. The method includes a following step(s).
In S2110, device information of a first device is received.
In S2120, it is determined whether the first device has a function of positioning and/or tracking according to the device information.

The second device may be a device located around the first device.

The device information of the first device can be used by the second device to determine functions of the first device.

For example, the second device may determine whether the first device has the function of positioning and/or tracking based on the device information of the first device.

In some embodiments of this disclosure, S2110 may include: monitoring an SL broadcast link and/or a WiFi broadcast link, and obtaining the device information of the first device. In this way, the second device can promptly determine whether there are other devices with the function of positioning and/or tracking nearby, thereby avoiding the second device from being positioned and/or tracked without any awareness.

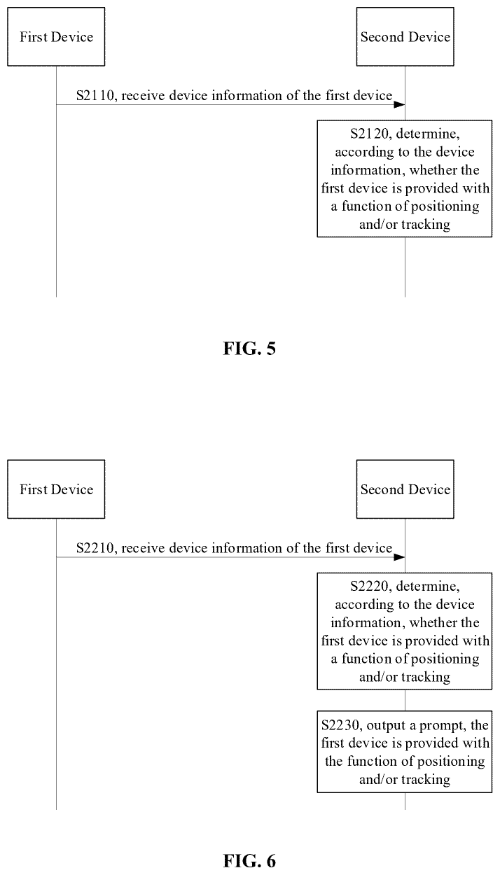

As shown in FIG. 6, an embodiment of this disclosure provides an information processing method, which is performed by a second device. The method includes a following step(s).
In S2210, device information of a first device is received.
In S2220, it is determined whether the first device has a function of positioning and/or tracking according to the device information.
In S2230, a prompt is output when the first device has the function of positioning and/or tracking, where the prompt is used to remind that the first device has the function of positioning and/or tracking.

That is, when the second device determines that the first device has the function of tracking and/or positioning based on the device information of the first device, it can output a prompt, where the prompt information is used to inform that there is a tracking and/or positioning device nearby. If the user is sensitive to his or her location information and/or privacy, he or she can check, among carried items, whether there are devices that are illegally put in for tracking and/or positioning.

For example, when the second device determines that the first device has the function of positioning and/or positioning based on the device information of the first device, it can output a police-calling prompt and detect an operation with respect to the police-calling prompt. In this way, through calling police, the police can be requested to assist in identifying nearby devices performing illegal positioning and/or tracking.

The police-calling prompt here is one of the aforementioned prompt messages.

The prompt may include: displayed text information, prompt sound, prompt light, or the like.

Outputting the prompt may include at least one of the following:
displaying prompt information;
broadcasting prompt voice; and
displaying prompt light.

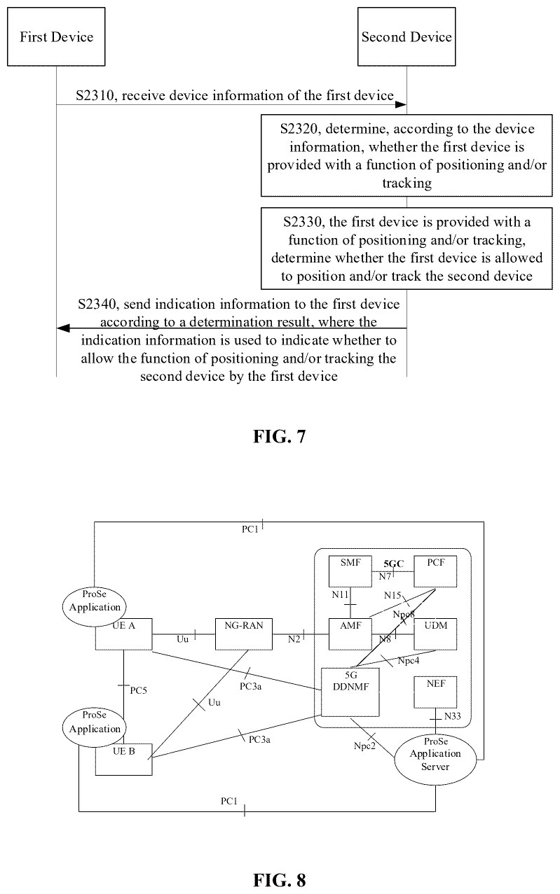

As shown in FIG. 7, an embodiment of this disclosure provides an information processing method, which is performed by a second device. The method includes a following step(s).
In S2310, device information of a first device is received.
In S2320, it is determined whether the first device has a function of positioning and/or tracking according to the device information.
In S2330, when the first device has the function of positioning and/or tracking, it is determined whether the first device is allowed to position and/or track the second device.
In S2340, indication information is sent to the first device according to a determination result, where the indication information indicates whether to allow the first device to position and/or track the second device.

In some embodiments, S2330 may include: determining, when the first device has the function of positioning and/or tracking, whether to allow the first device to position and/or track the second device by outputting prompts and/or settings of the second device for positioning and/or tracking.

For example, a pop-up window is used to output prompt information indicating whether the first device is allowed to position and/or track the second device. If confirmation feedback is detected from the user, it can be considered that the user wants the first device to position and/or track the second device.

As another example, a pop-up window is used to output prompt information indicating whether the first device is allowed to position and/or track the second device. If confirmation feedback is detected from the user, it can be considered that the user wants the first device to position and/or track the second device.

In some embodiments, the second device determines to allow the first device to position and/or track the second device according to the user's setting operation or the device's default configuration; or, the second device determines to prohibit the first device to position and/or track the second device according to the user's setting operation or the device's default configuration.

In some embodiments, receiving the device information of the first device includes:
receiving an announcement message from the first device, where the announcement message includes the device information;
and/or,
receiving a request message from the first device, where the request message includes the device information.

In some embodiments, both the announcement message and the request message may be messages sent by the first device on the SL broadcast channel and/or the WiFi broadcast channel.

In some embodiments, the device information includes:
a device identifier of the first device; and
device type information of the first device, where the device type information is used by the second device to determine that the first device corresponding to the device identifier has the function of positioning and/or tracking.

FIG. 8 shows a network architecture that can be used for positioning, which can include:
5GC (5th Generation core), including SMF (Session Management Function), AMF (Access Management Function), NEF, and 5G DDNMF (direct discovery name management function), PCF (Policy Control Function) and UDM;
NG-RAN (Next Generation Radio Access Network);
UE B; and
UE A, where a proximity service (Prose) application is deployed on UE A and can be connected to a ProSe application server through DDNMF.

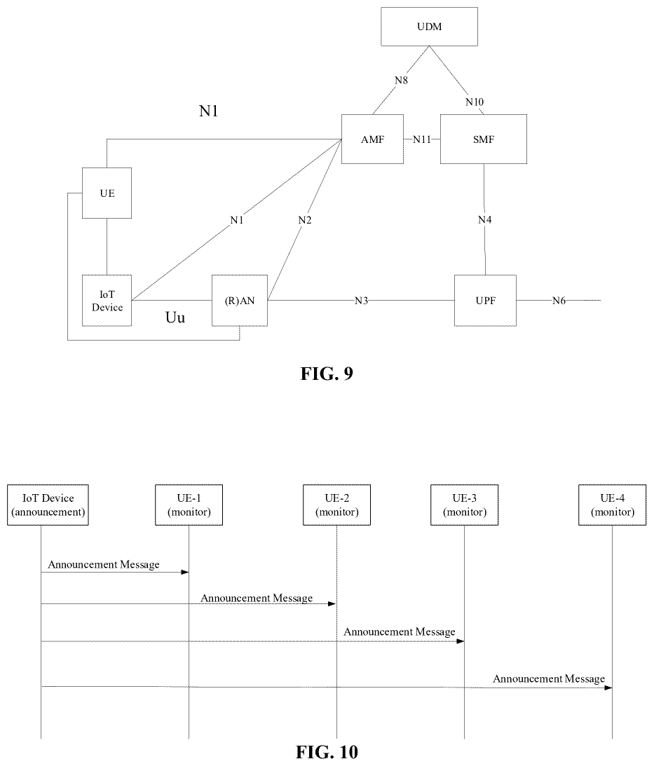

Uu, N1 to N11 and the like in FIG. 9 are all interfaces between corresponding functional network elements (i.e., network device).

The Prose application server here may be one of the aforementioned AFs.

FIG. 9 shows a network architecture that can be used for positioning, which may include: UDM, AMF, SMF, (R)AN, UPF (User Plane Function) and AF. IoT devices are connected to UPF through (R)AN and further connected to AF.

N8, N10, N1, N2, N3, N4, N6 and N11 in FIG. 9 are all interfaces between corresponding network elements (network devices).

In a specific application scenario, a householder or owner (i.e., the user) has a positioning-specific IoT device used to track the householder's items. But there may be some illegal usage scenarios, for example, this IoT device is used to track other people who do not allow such tracking. It is assumed that there is an IoT device specifically used for positioning to inform surrounding UEs of the IoT device type for positioning or tracking.

In this way, when the UEs around the IoT device receive notifications from the IoT device, they can know in time whether there are other devices with the function of positioning and/or tracking around them, so as to make corresponding response strategies.

As shown in FIG. 10, an embodiment of this disclosure provides an information processing method, including the following content.

The IoT device notifies other UEs that it has the function of positioning and/or tracking. As shown in FIG. 10, it sends an announcement message. The announcement message may include: discovery message type, ProSe service code or ProSe restriction code, security protection element, user information ID of the announced user, and device type. Surrounding UE-2/3/4 receives the announcement message. This device type can be used to identify positioning/tracking IoT devices.

The discoverer IoT device sends a request (solicit) message. The request message may include discovery message type, ProSe query code, security protection element, discoverer's user information ID, and device type (locating/tracking IoT devices).

The discoveree UE that matches the request message responds with a response message to inform the device and sends the response message. The response message may include discovery message type, ProSe response code, and security protection element.

In the process of direct discovery of 5G ProSe using Model B, IoT devices may serve as discoverers.

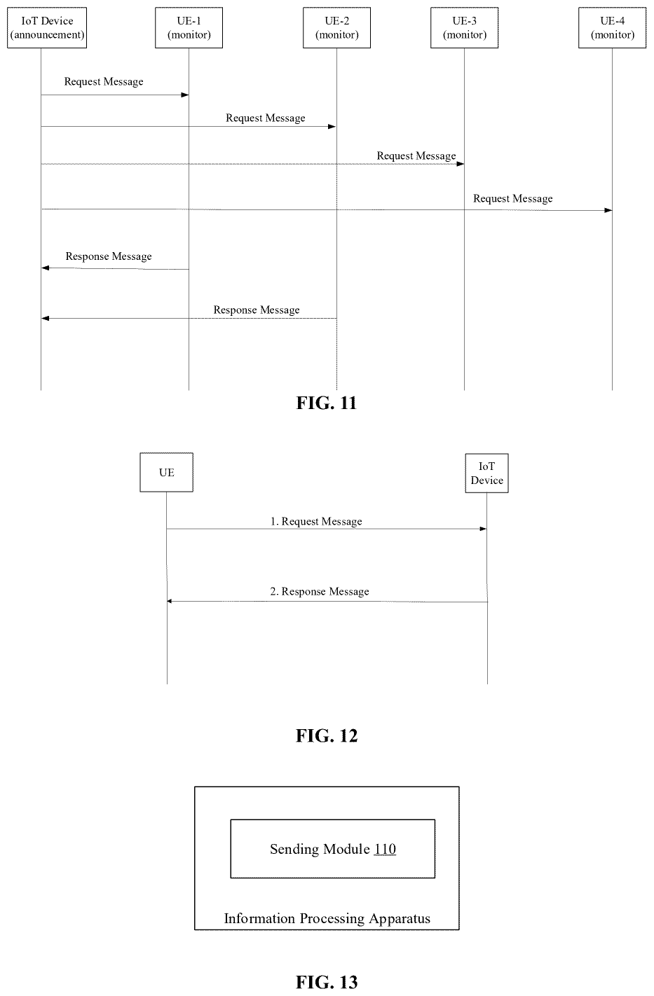

As shown in FIG. 11 and FIG. 12, the discoverer UE (IoT device in FIG. 11) sends a request message. The request message may include discovery message type, ProSe service code, security protection element, and user information ID about the discoverer. The security protection element may include security capabilities supported by the UE, for example, security algorithms supported by the UE, and the like.

The discoveree IoT device that match the request message respond with a response message to the discoveree UE. The response message may include discovery message type, ProSe response code, security protection element, and device type (positioning/tracking IoT device).

The positioning/tracking IoT device can then be known to surrounding UE(s). UE can display IoT device information (user information ID, device type) to the user. It is up to the user to decide and report to an authorized organization (e.g., the police) whether the IoT device is being used illegally for tracking or positioning.

Illegal use of special IoT positioning device for tracking and positioning is prohibited.

As to announcement message, request message and response message, a following parameter(s) may be newly added therein: device type of IoT device, where a candidate positioning type may include: positioning/tracking function type.

The IoT device information (device ID, device type) received by the surrounding UE can be displayed to the user. It is up to the user to decide and report if the IoT device is being illegally used for tracking or positioning.

As shown in FIG. 13, an embodiment of this disclosure provides an information processing apparatus, where the apparatus includes:
a sending module 110, configured to send device information of a first device to a second device, where the device information is used by the second device to determine that the first device has a function of positioning and/or tracking the second device.

The information processing apparatus provided by the embodiment of this disclosure may be included in the first device.

In some embodiments, the sending module 110 may be a program module. After the program module is executed by a processor, the above operations can be implemented.

In other embodiments, the sending module 110 may be a soft-hard combination module which includes, but is not limited to a programmable array, and the programmable array includes, but is not limited to, a field programmable array and/or a complex programmable array.

In yet other embodiments, the sending module 110 may be a pure hardware module, which may include but is not limited to an application specific integrated circuit.

In some embodiments, the device information includes:
a device identifier of the first device; and
a device type information of the first device.

In some embodiments, the device type information is used by the second device to determine that the first device corresponding to the device identifier has the function of positioning and/or tracking.

In some embodiments, the sending module 110 is configured to send an announcement message including the device information, and the announcement information includes the device information.

In some embodiments, the sending module 110 is configured to send a request message including the device information.

In some embodiments, the apparatus further includes:
a receiving module, configured to receive a response message sent by the second device, where the response message includes: indication information indicating whether the first device is allowed to position or track the second device; and
a first determining module, configured to determine, according to the response message, whether to stop positioning and/or tracking the second device.

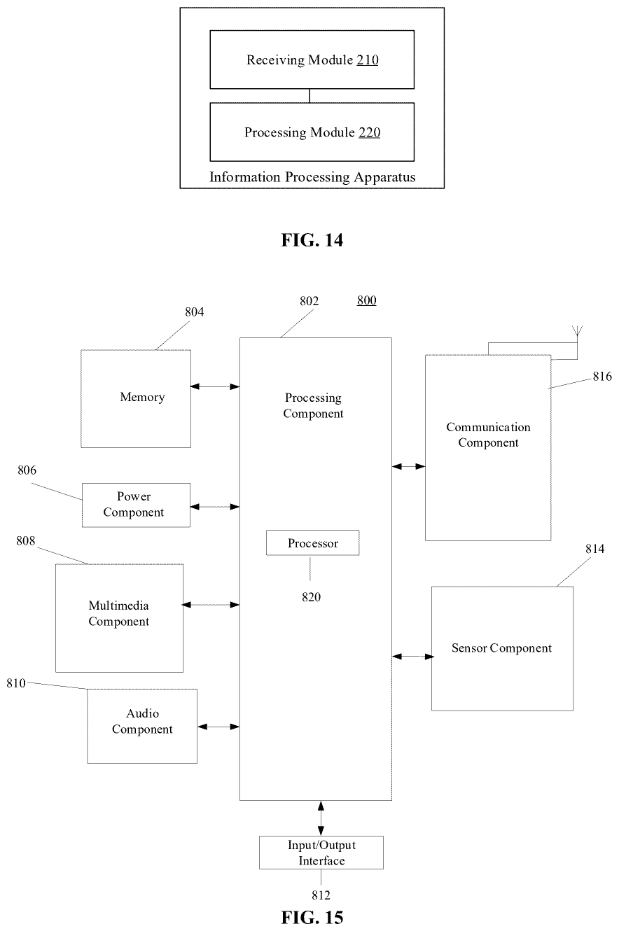

As shown in FIG. 14, an embodiment of this disclosure provides an information processing apparatus, where the apparatus includes:
a receiving module 210, configured to receive device information of a first device; and
a processing module 220, configured to determine whether the first device has a function of positioning and/or tracking according to the device information.

The information processing apparatus may be included in a second device.

In some embodiments, the receiving module 210 and the processing module 220 may be program modules. After the program modules are executed by a processor, the above operations can be implemented.

In other embodiments, the receiving module 210 and the processing module 220 may be soft-hard combination modules which include, but is not limited to programmable arrays, and the programmable arrays include, but are not limited to, field programmable arrays and/or complex programmable arrays.

In yet other embodiments, the receiving module 210 and the processing module 220 may be pure hardware modules, which may include but is not limited to application specific integrated circuits.

In some embodiments, the apparatus further includes:
an outputting module, configured to output a prompt that the first device has the function of positioning and/or tracking, where the prompt is used to remind that the first device has the function of positioning and/or tracking.

In some embodiments, the apparatus further includes:
a processing module, configured determine, the first device has the function of positioning and/or tracking, whether the first device is allowed to position and/or track the second device; and
a sending module, configured to send indication information to the first device according to a determination result, where the indication information is used to indicate whether to allow the function of positioning and/or tracking the second device by the first device.

In some embodiments, the receiving module 210 is configured to receive an announcement message from the first device, where the announcement message includes the device information; and/or to receive a request message from the first device, where the request message includes the device information.

In some embodiments, the device information includes:
a device identifier of the first device; and
a device type information of the first device.

An embodiment of this disclosure provides a communication device, including:
a memory, configured to store instructions executable by a processor;
a processor, respectively connected to the memory;
where the processor is configured to implement the information processing method according to any of the foregoing technical solutions.

The processor may include various types of storage medium, which are non-transitory computer storage medium that can continue to store information stored thereon after the communication device is powered off.

Here, the communication device includes: a UE or a network element, and the network element may be any one of the aforementioned first to fourth network elements.

The processor may be connected to the memory through a bus, etc., and be used to read the executable program stored in the memory, for example, as shown in any one of FIG. 2 to FIG. 7 or FIG. 10 to FIG. 12.

FIG. 15 is a block diagram showing a UE 800 according to some embodiments. For example, the UE 800 may be a mobile phone, a computer, a digital broadcast terminal, a messaging device, a game console, a tablet device, a medical device, a fitness device, a personal digital assistant, and the like.

Referring to FIG. 15, the UE 800 may include one or more of the following components: processing component 802, memory 804, power component 806, multimedia component 808, audio component 810, input/output (I/O) interface 812, sensor assembly or component 814, and communication component 816.

The processing component 802 generally controls the overall operation of the UE 800, such as operations associated with display, phone calls, data communications, camera operations, and recording operations. The processing component 802 may include one or more processors 820 to execute instructions to perform all or some of the steps of the methods described above. Additionally, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support operation at the UE 800. Examples of such data include instructions, contact data, phonebook data, messages, pictures, videos, and the like for any application or method operating on the UE 800. The memory 804 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 806 provides power to various components of the UE 800. The power component 806 may include a power management system, one or more power sources, and other components associated with generating, managing, and distributing power to the UE 800.

The multimedia component 808 includes a screen that provides an output interface between the UE 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 808 includes a front camera and/or a rear camera. When the UE 800 is in an operation mode, such as a shooting mode or a video mode, the front camera and/or the rear camera may receive external multimedia data. Each of the front and rear cameras may be a fixed optical lens system or have focal length and optical zoom capability.

The audio component 810 is configured to output and/or input audio signals. For example, the audio component 810 includes a microphone (MIC) that is configured to receive external audio signals when the UE 800 is in operating modes, such as calling mode, recording mode, and voice recognition mode. The received audio signal may be further stored in the memory 804 or transmitted via the communication component 816. In some embodiments, the audio component 810 also includes a speaker for outputting audio signals.

The I/O interface 812 provides an interface between the processing component 802 and a peripheral interface module, which may be a keyboard, a click wheel, a button, or the like. These buttons may include, but are not limited to: home button, volume buttons, start button, and lock button.

The sensor assembly 814 includes one or more sensors for providing status assessments of various aspects of the UE 800. For example, the sensor assembly 814 can detect the open/closed state of the UE 800, the relative positioning of components, such as the display and keypad of the UE 800. The sensor assembly 814 can also detect a change in the position of the UE 800 or a component of the UE 800, the presence or absence of user contact with the UE 800, the orientation or acceleration/deceleration of the UE 800, and the temperature change of the UE 800. The sensor assembly 814 may include a proximity sensor configured to detect the presence of nearby objects in the absence of any physical contact. The sensor assembly 814 may also include a light sensor, such as a CMOS or CCD image sensor, for use in imaging applications. In some embodiments, the sensor assembly 814 may also include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access wireless networks based on communication standards, such as WiFi, 2G or 3G, or a combination thereof. In some embodiments, the communication component 816 receives broadcast signals or broadcast related information from an external broadcast management system via a broadcast channel. In some embodiments, the communication component 816 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the UE 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components, which are configured to perform the forgoing methods.

In some embodiments, there is also provided a non-transitory computer-readable storage medium including instructions, such as the memory 804 including instructions, executable by the processor 820 of the UE 800 to perform the method described above. For example, the non-transitory computer-readable storage medium may be ROM, random access memory (RAM), CD-ROM, magnetic tape, floppy disk, optical data storage device, and the like.

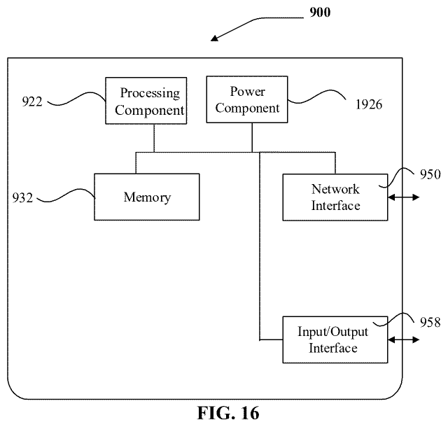

As shown in FIG. 16, it shows a structure of an access device according to some embodiments. For example, the communication device 900 may be provided as a network device, which may be the various network element such as the access network element and/or network function as described above.

Referring to FIG. 16, the communication device 900 includes a processing component 922, which further includes one or more processors; and a memory resource represented by memory 932 for storing instructions executable by the processing component 922, such as application programs. The application program stored in memory 932 may include one or more modules each corresponding to a set of instructions. In addition, the processing component 922 is configured to execute instructions to perform the forgoing methods, for example, the method as shown in any one of FIGS. 2 to s7 or FIGS. 10 to 12.

The communication device 900 may also include a power component 926 configured to perform power management of the communication device 900, a wired or wireless network interface 950 configured to connect the communication device 900 to a network, and an input-output (I/O) interface 958. The communication device 900 can operate based on an operating system stored in the memory 932, such as Windows Server™, Mac OS X™, Unix™, Linux™, FreeBSD™ or the like.

Other embodiments of this disclosure will be readily apparent to those skilled in the art from consideration of the specification and practice of the invention disclosed herein. This application is intended to cover any modification, use or adaptation of this disclosure, and these modifications, uses or adaptations follow the general principles of this disclosure and include common knowledge or conventional technical means in the art, which are not disclosed in this disclosure. The specification and examples are to be considered exemplary only, with a true scope and spirit of the disclosure being indicated by the following claims.

It should be understood that this disclosure is not limited to the precise constructions which have been described above and shown in the drawings, and various modifications and changes may be made without departing from the scope thereof. The scope of this disclosure is limited only by the scope of the appended claims.

1. An information processing method, being performed by a first device and comprising:
sending device information of the first device to a second device, wherein the device information is used to indicate that the first device is provided with a function of positioning or tracking the second device.

2. The method according to claim 1, wherein the device information comprises:
a device identifier of the first device; and
a device type information of the first device.

3. The method according to claim 1, wherein
sending the device information of the first device to the second device comprises:
sending an announcement message, wherein the announcement message comprises the device information.

4. The method according to claim 1, wherein sending the device information of the first device to the second device comprises:
sending a request message, wherein the request message comprises the device information.

5. The method according to claim 4, further comprising:
receiving a response message sent by the second device, wherein the response message comprises: indication information indicating whether the first device is allowed to position or track the second device; and
determining, according to the response message, whether to stop positioning or tracking the second device.

6. An information processing method, being performed by a second device and comprising:
receiving device information of a first device; and
determining, according to the device information, whether the first device is provided with a function of positioning or tracking the second device.

7. The method according to claim 6, further comprising:
outputting a prompt, wherein the prompt is used to remind that the first device is provided with the function of positioning or tracking.

8. The method according to claim 6, further comprising:
determining whether the first device is allowed to position or track the second device; and
sending indication information to the first device according to a determination result, wherein the indication information is used to indicate whether to allow the function of positioning or tracking the second device by the first device.

9. The method according to claim 6, wherein receiving the device information of the first device comprises:
receiving an announcement message from the first device, wherein the announcement message comprises the device information; or,
receiving a request message from the first device, wherein the request message comprises the device information.

10. The method according to claim 6, wherein the device information comprises:
a device identifier of the first device; and
a device type information of the first device.

11.-22. (canceled)

23. The method according to claim 2, wherein sending the device information of the first device to the second device comprises:
sending an announcement message, wherein the announcement message comprises the device information.

24. The method according to claim 2, wherein sending the device information of the first device to the second device comprises:
sending a request message, wherein the request message comprises the device information.

25. A first device, comprising a processor, a transceiver, a memory, and an executable program stored in the memory and able to be executable by the processor, wherein the processor, upon running the executable program, is configured to:
send device information of the first device to a second device, wherein the device information is used to indicate that the first device is provided with a function of positioning or tracking the second device.

26. The first device according to claim 25, wherein the device information comprises:
a device identifier of the first device; and
a device type information of the first device.

27. The first device according to claim 25, wherein the processor is configured to:
send an announcement message, wherein the announcement message comprises the device information.

28. The first device according to claim 25, wherein the processor is configured to:
send a request message, wherein the request message comprises the device information.

29. The first device according to claim 28, wherein the processor is further configured to:
receive a response message sent by the second device, wherein the response message comprises: indication information indicating whether the first device is allowed to position or track the second device; and
determine, according to the response message, whether to stop positioning or tracking the second device.

30. A communication device, comprising a processor, a transceiver, a memory, and an executable program stored in the memory and able to be executable by the processor, wherein the processor, upon running the executable program, is configured to implement the information processing method according to claim 6.

31. A non-transitory computer storage medium storing an executable program thereon, wherein the executable program is used for, upon being executed by a processor, implementing the method according to claim 1.

32. A non-transitory computer storage medium storing an executable program thereon, wherein the executable program is used for, upon being executed by a processor, implementing the method according to claim 6.
